(19) United States
(12) Patent Application Publication
(10) Pub. No.: US 2002/0062340 A1
(43) Pub. Date: May 23, 2002

(54) System for modifying a web page

(76) Inventors: Michael Kloecker, Muenchen (DE); Heiko Straulino, Planegg-Martinsried (DE)

Correspondence Address: STAAS & HALSEY LLP, 700 11TH STREET, NW, SUITE 500, WASHINGTON, DC, 20001, US

(21) Appl. No.: 09/955,487

(22) Filed: Sep. 19, 2001

(30) Foreign Application Priority Data
Sep. 19, 2000 (EP) 120487.4

(51) Int. Cl. G06F 15/16

(52) U.S. Cl. 709/203; 707/513

(57) ABSTRACT

In a client which contains a web page, having at least one associated modification interface, and at least one applet, with at least one connection existing between the applet and at least one server, the server sends at least one first message to the applet, the applet then sends the modification interface a second message, and the web page is modified taking into account the second message. This produces a server push mechanism in which the web pages are advantageously produced only in HTML. Complex production of the web page in a programming language such as Java is thus not necessary.

### BACKGROUND OF THE INVENTION

1. Field of the Invention

The present invention is directed to a system for modifying a web page.

2. Description of the Related Art

Web pages are files which are transmitted to HTTP clients—also called ‘browsers’—on the World Wide Web (WWW) using the Hypertext Transfer Protocol (HTTP) of HTTP servers —also called ‘web servers’—and are normally displayed by the HTTP clients.

In this context, HTTP is a set of rules for exchanging text files, image files, sound files, video files and/or other multimedia files on the WWW. In relation to the TCP/IP protocol suite, HTTP is an application protocol within the context of the ISO OSI reference model. With the TCP/IP, information is exchanged using “flows” which, despite the connectionless nature of the TCP/IP, connect sender and recipient (e.g., web server and browser) to one another on a logically abstract level, i.e., in logically abstract terms flows can also be called connections.

A fundamental concept of HTTP is that files can contain references to other files. Selecting these references initiates additional transmission requests. To this end, each web server contains not only the web pages but also an HTTP demon. This is a program which continuously waits for HTTP requests and processes them when they arrive. Each browser is an HTTP client, for example, which sends requests to web servers. When a user of the browser enters a request, either by typing in a Uniform Resource Locator (URL) or by selecting a hypertext link, the browser generates an HTTP request and uses the TCP/IP to send it to the Internet address corresponding to the entered URL. The HTTP demon in the addressed HTTP server receives this request, processes it and returns the requested file(s)—this is referred to as a response to a request.

One specific form of web pages are “HTML files”—also called ‘HTML pages’. Besides the actual information (e.g., text and/or images), these contain additional instructions which is written in Hypertext Markup Language (HTML). HTML is an international standard which is recommended by the World Wide Web Consortium (W3C) and is observed by the most widely used browsers at the present time—Microsoft's Internet Explorer and Netscape's Navigator. HTML comprises a set of markup symbols—also called ‘codes’—which are used by the browser to display the information in a particular way. An individual markup symbol is also called an ‘element’ or a ‘tag’. A recent version of HTML is HTML 4.0. Significant service features of HTML 4.0 are sometimes also referred to generally as ‘dynamic HTML’.

Besides the standardized codes, each browser supports respective additional proprietary extension codes. Examples of these which may be mentioned are “scripts”, for example called ‘JavaScript’ by Netscape, ‘Visual Basic Script (VB Script)’ by Microsoft, ‘Tool Command Language’ by Sun and ‘Restructured Extended Executor’ by IBM. Scripts are described below using the example of JavaScripts without restricting the general nature.

JavaScript is an interpreted programming and script language developed by Netscape. It is currently widely supported both by Microsoft's Internet Explorer and by Netscape's Navigator. In principle, a script language is easier to understand and faster to code than a compiler language such as C, C++ or Java. A script language is much slower upon execution than a compiler language, however. Scripts are therefore frequently used in relatively short programs. By way of example, JavaScript is used in web pages in order to change the display of information in the browser as the mouse is moved over it. JavaScript program parts can be positioned within HTML pages. They are normally interpreted by the browser. JavaScript program parts can also run on web servers, such as in Microsoft's Active Server Pages, before a page is sent to the requesting client.

Although JavaScript uses some of the ideas which can also be found in the compiler language Java, JavaScript as an interpreted language and Java as a compiled language are otherwise fundamentally very different, despite the similar name, and should not be confused with one another.

Unlike JavaScript, Java is an object-oriented, compiled programming language which was expressly developed for use in the distributed environment of the Internet. It was introduced by Sun Microsystems in 1995 and has undergone continuous further development since that time.

Java programs are compiled in a “Java bytecode”, which can be executed by any computer which has a Java Virtual Machine (JVM) installed on it. The JVM interprets the Java bytecode, i.e., translates the byte-code into machine commands which can be executed by the real hardware. In this context, individual characteristics of the computer hardware platform, such as the length of the machine commands, are adjusted by the respective local JVM when the Java bytecode is executed (optionally, the JVM can also use a just-in-time (JIT) compiler to translate the Java bytecode dynamically into locally executable code, with dynamic JIT compilation being faster in many cases than step-by-step interpretation of the individual instructions of a Java bytecode). A Java program can thus run on any desired hardware platform. A JVM is currently provided both in Microsoft's Internet Explorer and in Netscape's Navigator. In addition, almost every manufacturer of operating systems currently has a Java compiler in its product range.

Java can firstly be used to develop complex applications which run either on a computer or distributed over a server and clients in a computer network. Secondly, Java can also be used to develop small application modules, e.g., applets, as part of a web page.

An applet is a small program which can be transmitted to a client together with a web page. An applet written in Java is also called a ‘Java applet’. Java applets can be used to produce interactive animations—e.g., interactions with the web page user—or to perform direct calculations without the need to send further requests to the server within this context. Java applets are interpreted by a restricted JVM in which commands critical to the system are not permitted. In particular, the Java objects of a Java applet fundamentally contain no references to external data or other objects. This means that an instruction cannot contain an address which point to data areas of other applications or of the operating system. Java applets have the advantage that they can be processed particularly quickly on account of the fact that they run in the client itself. Applets can also run in web servers and are then called ‘serviets’.

On the basis of the concepts described hitherto, requests are always initiated by the client. In this context, the full web page is transmitted for each request. For creating web pages for complex web applications, this model has only limited suitability. It is often necessary for the information displayed in the browser to be updated on the initiative of the server. By way of example, a financial application requires a web page on which the displayed market prices and/or stock portfolio values are updated cyclically in the browser.

For this purpose, automated, cyclic polling of the server, initiated by the browser, is known. For this, a special HTML tag is used which prompts the browser to send a new request to the server automatically after a certain time. Such a tag has the following appearance, for example:

<META HTTP-EQUIV=“Refresh” CONTENT=“12; URL=http://xyz”>

This tag instructs the browser to request the URL http://xyz again after 12 seconds. This causes a high server and network load, because the web pages are also requested when no change has taken place.

In an alternative method, the server indicates a specific content type “multipart/x-mixed -replaced” in the response to an HTTP request. This prompts the browser to maintain the connection to the server. The server can then send a new web page at any time via the existing connection. In this context, the full web page always has to be transmitted, which causes an unnecessarily high network load. In addition, only the full web page can be updated, which conflicts with appealing display of the web page.

Another method is the channels provided by Netscape and Microsoft. Browsers register with a channel and then receive all the contents distributed via the channels. However, the broadcast architecture of this method means that information personalized for a user, such as the current value of a stock portfolio, cannot be transmitted.

In addition, user interfaces can be produced and displayed entirely by Java applets. In this context, application-specific interfaces and communications protocols are provided between browser and server. This is much more complex as compared with creating user interfaces using HTML, because it requires particularly good knowledge of the programming language Java on account of the complexity of user interfaces. The programming of a user interfaces in Java is much more difficult to learn and implement than in the comparatively simply structured HTML.

### SUMMARY OF THE INVENTION

It is an object of the invention to find an improved concept for modifying web pages.

A fundamental aspect of the invention is that, in a client which contains a web page, having at least one associated modification interface, and at least one applet, with at least one connection existing between the applet and at least one server, the server sends the applet at least one first message for modifying the web page in the connection, the applet then sends the modification interface at least one second message, and the web page is modified taking into account the second message.

A few fundamental advantages of the invention include:

Information displayed in the browser can be updated upon the initiative of the server—this method is also called “server push” below.

No changes specific to the invention are required on the client computer or browser (e.g., installation of applications or extensions on the browser). Web pages developed in accordance with the invention can thus be modified using any browser which supports applets and modification interfaces—e.g., in the form of dynamic HTML.

The web page can be produced in HTML, which takes up less time and is less complex than producing it in a programming language such as Java.

Applet, modification interface and server push are used generically and can thus be used for any web pages without modification. Web page developers do not need to adapt the applet or its use of the modification interface.

In accordance with one refinement of the inventive method, the modification interface is in the form of a script. Scripts are already supported as part of dynamic HTML by virtually any browser today. The inventive method can thus be implemented without changing the existing browsers. With appropriate definition of a modification interface—e.g., as an integral part of HTML web pages—, it would naturally also be possible in future to dispense with the indirect route via a script.

In accordance with another refinement of the inventive method, the applet is identified using a session identifier (SID) known to the server. This allows a web server to distinguish between a plurality of browsers gaining access simultaneously.

In accordance with one variant of the inventive method, the address of the server is transferred to the applet as a parameter or is determined from the program code of the applet. These are two refinements in which the applet very efficiently ascertains the web server's address required for setting up the connection to the web server.

In accordance with one development of the inventive method, for a web page in which at least one modifiable area is identified by a tag identifier (TID), at least the TID is transmitted in the two messages if only the area is to be modified. This advantageously allows any detail of the page displayed in the browser to be updated. The full page does not need to be reloaded. Transmitting the update advantageously requires fewer network resources than transmitting the full page.

### BRIEF DESCRIPTION OF THE DRAWINGS

The invention is explained in more detail below using exemplary embodiments shown in one figures, in which:

FIG. 1 is an inventive arrangement for carrying out the inventive method.

### DETAILED DESCRIPTION OF THE PREFERRED EMBODIMENTS

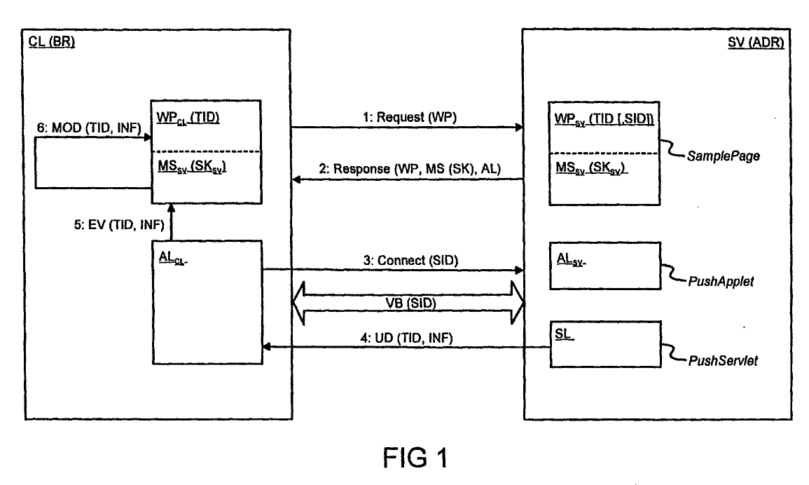

FIG. 1 shows, by way of example, two inventive devices, a server SV and a client CL. Both devices CL, SV contain a respective inventive web page WP, having an associated inventive modification interface MS, and an inventive applet AP. In this case, an appropriate index CL or SV indicates the association with the respective device CL, SV. The client CL is the form of a browser BR, for example, and the modification interface MS is in the form of a script SK, for example. The server SV also contains an inventive servlet SL.

Between client CL and server SV there is a connection VB which is optionally identified by a session identifier SID. In this context, the term “connection” is not to be understood as a restriction to the extent that only connection-oriented connection techniques, such as ATM or landline dialing connections, would be meant. Instead, it is obvious to a person skilled in the art of the relevant field that any desired connection techniques, i.e., in particular also connectionless connection techniques, such as TCP/IP, can be used.

In addition, the following messages are shown:

1: Request (WP): from the browser BR to the server SV to request that the web page WP_{SV} be transmitted.

2: Response (WP, MS (SK), AL): from the server SV to the browser BR to transmit the web page WP_{SV}, the modification interface MS_{SV}, for example in the form of scripts SK_{SV}, and the applet AP_{SV}.

3: Connect (SID): from the applet AP_{CL} to the server SV to set up the connection VB.

4: UD (TID, INF): from the servlet SL to the applet AL_{CL} to transmit an information item INF for modifying the web page WP_{CL} and optionally a tag identifier TID for identifying the information item INF to be modified in the WP_{CL}. This message is also called an ‘update’.

5: EV (TID, INF): from the applet AL_{CL} to the modification interface MS_{CL} to forward the information item INF and the tag identifier TID. This message is also called an ‘event’.

Finally, the action 6: MOD (TID, INF) for modifying the web page WP_{CL} is shown.

The code of the web page WP having an associated modification interface MS is stored, for example, in a file “SamplePage”, that of the applet AL is stored in a file “PushApplet”, and that of the servlet SL is stored in a file “PushServlet”.

For an exemplary embodiment of the invention, the text below illustrates one exemplary implementation of the inventive components web page WP, modification interface MS, applet AL and servlet SL. The modification interface MS is in the form of a script SK, for example. The web page WP is coded in HTML, the script SK is coded in JavaScript, and the applet AL and the servlet SL are coded in Java. Elements fundamental to the invention are identified by preceding comments in order to simplify understanding of the codes.

The specifically defining design of the modification interface MS as script SK and also the implementations in specific language should not be understood to be restrictive in this case. For a person skilled in the art of the relevant field, it is obvious that the inventive components can be implemented in any languages and using any interfaces.

“SamplePage” file with web page WP and Script SK

<HTML>
<HEAD>
<META HTTP-EQUIV=“Content-Type”

content=“text/html; charset=iso-8859-1”>

<TITLE>Document Title</TITLE>
</HEAD>
<BODY>

| | |
|---|---|
| <object | name=“PushApplet” |
| | code=“PushApplet” |
| | codebase = “some_directory”> |

<param name=“FiresScriptEvents” value=“true”>
<! COMMENT SID_DEF: This defines the session ID SID>
<param name=“SessionID” value=“1234”>
</object>
<! COMMENT TID_DEF: This defines the tag ID TID as “100” for
the subsequent information item.>
<div id=“ID0”>
VALUE OF STOCK OPTION XY: USD 100.00

(UPDATED AT 12:00, 01.01.2000)

</div>
<!COMMENT SK_DEF: This inserts a script SK defined as JavaScript
directly into the HTML file SamplePage.
<!COMMENT EV_DEF: In this case, the event EV is defined as
“push(e)” within this SCRIPT tag.>
<script

language=“JavaScript” for=“PushApplet”
event=“push(e)”>

document.all(e.getElement( )).innerHTML = e.getValue( );
</script>
</BODY>
</HTML>

“PushApplet” file with applet AL

// Class PushApplet (Extention of class Applet)
//
// public methods of class PushApplet:
// *01* void init( )
// *02* void stop( )
// *03* void run( )
import java.util.*;
import java.applet.*;
import java.net.*;
import java.io.*;
public class PushApplet extends Applet implements Runnable {

private transient Vector m_myEventsListeners;
private Socket m_Socket = null;
private String m_SessionID = null;

//*01*//

public void init( ) {

// save session id
m_SessionID = getParameter(“SessionID”);

// COMMENT Connect: This sets up a connection VB from the
// applet AB to the server SV.
// open connection to server
String host = this.getCodeBase( ).getHost( );
try {

m_Socket = new Socket (host, 8000);
System.out.printIn

(“PushApplet: Connection to server established. ”);

(new Thread(this)).start( );

}
catch (Exception e) {

System.out.printIn

(“PushApplet: Failure. ” + e.getMessage( ));

}

```
  }
//*02*//
  public void stop( ) {
```

// exit immediately if no connection to server exists
if (m_Socket == null) { return; }
// terminate connection to server
try {

m_Socket.close( );
System.out.printIn

(“PushApplet: Connection to server closed. ”);

}
catch (Exception e) {

System.out.printIn

(“PushApplet: Failure. ” + e.getMessage( ));

}

```
  }
//*03*//
  public void run( ) {
```

try {

// COMMENT SID_SND: This transmits the SID to the
// serverSV
// send session id
DataOutputStream out =

new DataOutputStream(m_Socket.getOutputStream( ) );

DataInputStream in =

new DataInputStream(m_Socket.getInputStream( ));

out.writeUTF(m_SessionID);
out.flush( );
System.out.printIn

(“PushApplet: Session ID transmitted. ”);

// COMMENT UD_LST: This receives messages UD sent
// by the server SV
// receive updates
for (;;) {

String element = in.readUTF( );
String value = in.readUTF( );
System.out.printIn

(“PushApplet: Update Element ”
+ element
+ “ with value ”
+ value);

// COMMENT EV_SND: This sends the message EV
// to the script SK as an event push(e)
if (m_myEventsListeners != null) {

| PushServerEvent e = | |
|---|---|
| | new PushServerEvent(this,element,value); |
| // initiate update by triggering event(s) | |
| for | ( int i = 0 |
| | ; i <m_myEventsListeners.size( ) |
| | ; i++) |
| ( | (PushServerListener) |
| | m_myEventsListeners.elementAt(i)).push(e); |

}

}

```
  }
  catch (Exception e) {
```

System.out.printIn

(“PushApplet: Failure. ” + e.getMessage( ));

}

}
} // end of class PushApplet

“PushServlet” file with servlet SL

// Class PushServlet (Extention of class HttpServlet)
//
// public methods of class PushServlet:
// *11* void init(...)
// *12* void run( )
import javax.servlet.*;
import javax.servlet.http.*;
import java.io.*;
import java.net.*;
import java.util.*;
public class PushServlet extends HttpServlet implements Run-
nable {
ServerSocket m_ServerSocket = null;
Hashtable m_ClientSockets = new Hashtable( );
//*11*//
//Initialize global variables
public void init(ServletConfig config)
throws ServletException {

super.init (config);
try {

m_ServerSocket = new ServerSocket(8000);
(new Thread(this)).start( );

}
catch (Exception e) {

throw new ServletException

(“Cannot create ServerSocket”);

}

}
//*12*//
public void run( ) {

Socket socket = null;
try {

socket = m_ServerSocket.accept( );
// launch new handler thread
(new Thread(this)).start( );
// read session id
DataInputStream dataIn =

new DataInputStream (socket.getInputStream ( ));

DataOutputStream dataOut =

new DataOutputStream(socket.getOutputStream( ));

String sessionID = dataIn.readUTF( );
// store socket
m_ClientSockets.put (sessionID, socket);
// transmit update to client
try {

// COMMENT TID_SND: This inserts the tag ID TID
// to identify the area to be changed in the web
// page WP_{CL}
dataOut.writeUTF(“ID0”);
// COMMENT INF_SND: This inserts the updated
// information item INF into the message UD.
dataOut.writeUTF (“

VALUE OF STOCK OPTION XY: USD 123.45

(UPDATED AT 12.15, 01.01.2000)

”);

// COMMENT UD_SND: This sends the message UD
// from the servlet SV to the applet AP.
dataOut.flush( );

}
catch (Exception e) {

// failure, terminate session
m_ClientSockets.remove(sessionID);
break;

}

}
catch (Exception e) {
}

| | |
|---|---|
| | } |
| } | // end of class PushServlet |

In this exemplary embodiment, it is assumed that the browser BR already contains the web page WP having the associated script SKCL and the applet ALCL, that a connection VB already exists between the applet ALCL and the server SV, and that the web page WPCL is already displayed by the browser BR, i.e., that the following information item INF is displayed:

VALUE OF STOCK OPTION XY: USD 100.00 (UPDATED AT 12.00, 01.01.2000)

One option for providing the inventive components web page WP, script SK and applet AL in the browser BR is, by way of example, for—as described initially —an HTTP request to be sent from the browser BR to the server, and for the server then to transmit the inventive components web page WP, script SK and applet AL to the browser with an HTTP response. This method, which is not fundamental to the invention, is indicated in FIG. 1 by the messages 1: Request (WP) and 2: Response (WP, SK, AL).

One option for setting up the connection VB between browser BR and server SV is shown in the initialization method inito (see *01* in the code file PushApplet) of the applet AL (see COMMENT Connect and message 3: Connect (SID) in FIG. 1). In addition, the session identifier SID is transmitted to the server SV in this code file in the execution method run ( ) (see *03*) (see COMMENT SID_SND). In this context, the session identifier is defined in the code file SamplePage (see COMMENT SID_DEF).

The inventive modification method is initiated by the servlet SV in the execution method run( ) (see *12* in the code file PushServlet) by transmission of the message UD (see COMMENT UD_SND and message 4: UD (TID, INF) in FIG. 1). This message has at least the updated information item INF inserted into it (see COMMENT INF_SND). Optionally, a tag identifier for identifying the area to be changed is also inserted into the message UD (see COMMENT TID_SND). In this context, the tag identifier is defined in the web page WP (see COMMENT TID_DEF in the code file SamplePage). This inventive use of a tag identifier TID is optional and can thus also be omitted.

The sent message UD is received by the applet ALCL in the execution method run 0 (see *03* in the code file PushApplet) (see COMMENT UD_LST). The tag identifier TID and the updated information item INF are removed from the message UD and are sent to the script SKCL as message EV (see EV_SND and message 5: EV (TID, INF) in FIG. 1). In this context, the message EV is, by way of example, in the form of an event EV which is defined in the script SKCL as push(e) (see COMMENT EV_DEF in the code file SamplePage).

The event EV is received by the script SKCL defined in the code file SamplePage (see COMMENT SK_DEF). This script SK_{CL} provides a generic concept in which the previously displayed information item INF, possibly identified by the tag identifier TID, is replaced by the updated value of the information item INF. To this end, the tag identifier TID and the updated information item INF are removed from the message and are generically—id=e.getElement( ) and value=e.getvalue( )—inserted into a dynamic HTML command document.all (. . .). This then modifies the information item INF identified by the tag identifier TID taking into account the updated information item INF (see also action 6: MOD (TID, INF) in FIG. 1). After this modification, the browser BR displays the following:

VALUE OF STOCK OPTION XY: USD 123.45 (UPDATED AT 12.15, 01.01.2000)

What is claimed is:

1. A method for modifying a web page in a client which contains the web page, having at least one associated modification interface and at least one applet with at least one connection existing between the at least one applet and at least one server, comprising:
sending at least one first message from the at least one server to the at least one applet;
sending at least one second message from the at least one applet to the at least one associated modification interface; and
modifying the web page taking into account the at least one second message received via the at least one associated modification interface.

2. The method as claimed in claim 1, wherein the client is a browser which displays the web page.

3. The method as claimed in claim 1, wherein the at least one second message is a form of an event.

4. The method as claimed in claim 1, wherein the at least one associated modification interface is a script.

5. The method as claimed in claim 1, wherein the at least one connection is a TCP/IP connection.

6. The method as claimed in claim 1, wherein the at least one applet is identified using a session identifier known to the at least one server.

7. The method as claimed in claim 1, further comprising one of
transferring an address of the at least one server to the at least one applet as a parameter, and
determining the address of the at least one server from program code of the at least one applet.

8. The method as claimed in claim 1, wherein, for a web page in which at least one modifiable area is identified by a tag identifier, at least the tag identifier is transmitted in the at least one first and second messages if only the area is to be modified.

9. The method as claimed in claim 1, wherein the server executes at least one servlet to notify the at least one applet of changes to the web page.

10. The method as claimed in claim 1, wherein the at least one web page has associated therewith at least one modification interface and at least one applet.

11. A system for modifying a web page in a client which contains the web page, having at least one associated modification interface and at least one applet with at least one connection existing between the at least one applet and at least one server, comprising:
means for sending at least one first message from the at least one server to the at least one applet;
means for sending at least one second message from the at least one applet to the at least one associated modification interface; and
means for modifying the web page taking into account the at least one second message received via the at least one associated modification interface.

12. The system as claimed in claim 11, wherein the client is a browser which displays the web page.

13. The system as claimed in claim 11, wherein the at least one second message is a form of an event.

14. The system as claimed in claim 11, wherein the at least one associated modification interface is a script.

15. The system as claimed in claim 11, wherein the at least one connection is a TCP/IP connection.

16. The system as claimed in claim 11, wherein the at least one applet is identified using a session identifier known to the at least one server.

17. The system as claimed in claim 11, further comprising one of
means for transferring an address of the at least one server to the at least one applet as a parameter, and
means for determining the address of the at least one server from program code of the at least one applet.

18. The system as claimed in claim 11, wherein, for a web page in which at least one modifiable area is identified by a tag identifier, at least the tag identifier is transmitted in the at least one first and second messages if only the area is to be modified.

19. The system as claimed in claim 11, wherein the server executes at least one servlet to notify the at least one applet of changes to the web page.

20. The system as claimed in claim 11, wherein the at least one web page has associated therewith at least one modification interface and at least one applet.

21. At least one computer readable medium storing at least one program to control a processor to perform a process for modifying a web page in a client which contains the web page, having at least one associated modification interface and at least one applet with at least one connection existing between the at least one applet and at least one server, said process comprising:
sending at least one first message from the at least one server to the at least one applet;
sending at least one second message from the at least one applet to the at least one associated modification interface; and
modifying the web page taking into account the at least one second message received via the at least one associated modification interface.

22. The at least one computer readable medium as claimed in claim 21, wherein the client is a browser which displays the web page.

23. The at least one computer readable medium as claimed in claim 21, wherein the at least one second message is a form of an event.

24. The at least one computer readable medium as claimed in claim 21, wherein the at least one associated modification interface is a script.

25. The at least one computer readable medium as claimed in claim 21, wherein the at least one connection is a TCP/IP connection.

26. The at least one computer readable medium as claimed in claim 21, wherein the at least one applet is identified using a session identifier known to the at least one server.

27. The at least one computer readable medium as claimed in claim 21, further comprising one of
transferring an address of the at least one server to the at least one applet as a parameter, and
determining the address of the at least one server from program code of the at least one applet.

28. The at least one computer readable medium as claimed in claim 21, wherein, for a web page in which at least one modifiable area is identified by a tag identifier, at least the tag identifier is transmitted in the at least one first and second messages if only the area is to be modified.

29. The at least one computer readable medium as claimed in claim 21, wherein the server executes at least one servlet to notify the at least one applet of changes to the web page.

30. The at least one computer readable medium as claimed in claim 21, wherein the at least one web page has associated therewith at least one modification interface and at least one applet.

31. A system for modifying a web page, comprising:
at least one server to send at least one first message; and
a client device displaying the web page and executing
at least one applet to receive the at least one first message from the at least one server and to send at least one second message, and
at least one associated modification interface to receive the at least one second message from the at least one applet and to modify the web page based on the at least one second message.

32. The system as claimed in claim 31, wherein the client is a browser which displays the web page.

33. The system as claimed in claim 31, wherein the at least one second message is a form of an event.

34. The system as claimed in claim 31, wherein the at least one associated modification interface is a script.

35. The system as claimed in claim 31, wherein the at least one connection is a TCP/IP connection.

36. The system as claimed in claim 31, wherein the at least one applet is identified using a session identifier known to the at least one server.

37. The system as claimed in claim 31, wherein the at least one applet further obtains an address of the at least one server either as a parameter or from program code of the at least one applet.

38. The system as claimed in claim 31, wherein, for a web page in which at least one modifiable area is identified by a tag identifier, at least the tag identifier is transmitted in the at least one first and second messages if only the area is to be modified.

39. The system as claimed in claim 31, wherein the server executes at least one servlet to notify the at least one applet of changes to the web page.

40. The system as claimed in claim 31, wherein the at least one web page has associated therewith at least one modification interface and at least one applet.

41. A client device coupled to at least one server, comprising:
a display unit to display a web page; and
at least one processor to execute
at least one applet to request at least one first message from the server if the web page is to be modified, to receive the at least one first message from the at least one server and to send at least one second message, and
at least one associated modification interface to receive the at least one second message from the at least one applet and to modify the web page based on the at least one second message.
